(19) United States
(12) Patent Application Publication
(10) Pub. No.: US 2026/0351908 A1
(43) Pub. Date: Nov. 5, 2026

(54) COMPRESSION CONNECTOR DESIGN FOR INCREASED RELIABILITY AND SIMPLIFIED MANUFACTURE

(71) Applicant: JOHN MEZZALINGUA ASSOCIATES, LLC., Liverpool, NY (US)

(72) Inventors: Brandon STEVENS, Liverpool, NY (US); Thomas Sawyer URTZ, North Syracuse, NY (US); Jeremy BENN, Liverpool, NY (US)

(21) Appl. No.: 19/099,960

(22) PCT Filed: Jul. 12, 2024
(86) PCT No.: PCT/US2024/037692

§ 371 Date: Jan. 30, 2025

Related U.S. Application Data
(60) Provisional application No. 63/513,409, filed on Jul. 13, 2023.

(51) Int. Cl. H01R 24/40; H01R 9/05

(52) U.S. Cl. CPC H01R 24/40; H01R 9/0527

(57) ABSTRACT

A compression connector comprises a connector outer body; a connector inner conductor that is concentric to the connector outer body, the connector inner conductor having an inner conductor basket; a front insulator mechanically coupled to the connector outer body and mechanically coupled to the connector inner conductor basket, wherein the front insulator is configured to apply inward radial pressure on the connector inner conductor; a contact cone mechanically coupled to the connector outer body and configured to compress a flared cable outer conductor from a first side; a split clamp ring configured to be mechanically and electrically coupled to the connector outer body, the split clamp ring configured to compress the flared cable outer conductor from a second side, wherein the split clamp ring has two semicircular components that are configured to be joined together during a jumper compression assembly process; and a strain relief cap.

### BACKGROUND OF THE INVENTION

Modern cellular communications, such as LTE and 5G, place extreme demands on the RF (Radio Frequency) connectors and jumpers that carry the RF signals between cellular antennas and their base stations. The jumpers must carry a wide range of frequencies with minimal distortion, such as Passive Intermodulation (PIM) distortion. Accordingly, the RF connectors that are attached to the RF cables to form jumpers must be manufactured with great precision and reliability.

Two conventional methods for installing RF connectors onto RF cables include welding, and compression. Compression connectors offer an advantage in that they can be installed in the field by a technician. However, automated manufacturing may be desired for more efficient manufacturing.

Accordingly, what is needed is a reliable high performance RF connector that may be assembled into a jumper with a reduced number of manufacturing steps.

### SUMMARY OF THE INVENTION

An aspect of the disclosure involves a compression connector. The compression connector comprises a connector outer body; a connector inner conductor that is concentric to the connector outer body, the connector inner conductor having an inner conductor basket; a front insulator mechanically coupled to the connector outer body and mechanically coupled to the connector inner conductor basket, wherein the front insulator is configured to apply inward radial pressure on the connector inner conductor; a contact cone mechanically coupled to the connector outer body and configured to compress a flared cable outer conductor from a first side; a split clamp ring configured to be mechanically and electrically coupled to the connector outer body, the split clamp ring configured to compress the flared cable outer conductor from a second side, wherein the split clamp ring has two semicircular components that are configured to be joined together during a jumper compression assembly process; and a strain relief cap. Another aspect of the disclosure involves a compression connector that comprises a connector outer body; a connector inner conductor that is concentric to the connector outer body, the connector inner body having an inner conductor basket; a first insulator mechanically coupled to the connector outer body and mechanically coupled to the connector inner conductor; a second insulator mechanically coupled to the connector outer body and mechanically coupled to the inner conductor basket; a contact cone mechanically coupled to the connector outer body and configured to compress a flared cable outer conductor from a first side; a clamp ring configured to compress the flared cable outer conductor from a second side; and a strain relief cap.

### BRIEF DESCRIPTION OF DRAWINGS

FIG. 1A illustrates one end of an exemplary RF jumper with an exemplary compression connector affixed to an RF cable according to the disclosure.

FIG. 1B is a zoomed in view of FIG. 1A, illustrating possible dual conductive paths.

FIG. 2A illustrates another exemplary RF jumper with an exemplary compression connector affixed to an RF cable according to the disclosure.

FIG. 2B is a zoomed in view of FIG. 2A, illustrating locking ridges that hold the compression connector in place during assembly.

FIG. 3A illustrates an exemplary split clamp ring according to the disclosure.

FIG. 3B illustrates one half of the exemplary split clamp ring of FIG. 3A.

FIG. 4 illustrates another exemplary RF jumper with an exemplary compression connector affixed to an RF cable according to the disclosure, the compression connector having a reduced profile strain relief cap.

FIG. 5A illustrates another exemplary compression connector in its pre-compressed open state.

FIG. 5B illustrates the exemplary compression connector of FIG. 5A in its compressed state.

FIG. 5C is another view of the pre-compressed connector of FIG. 5A.

FIG. 5D illustrates the compression connector of FIG. 5B, in its compressed state, and installed on an RF cable.

FIG. 6 illustrates an exemplary co-molded strain relief cap according to the disclosure.

### DETAILED DESCRIPTION OF THE INVENTION

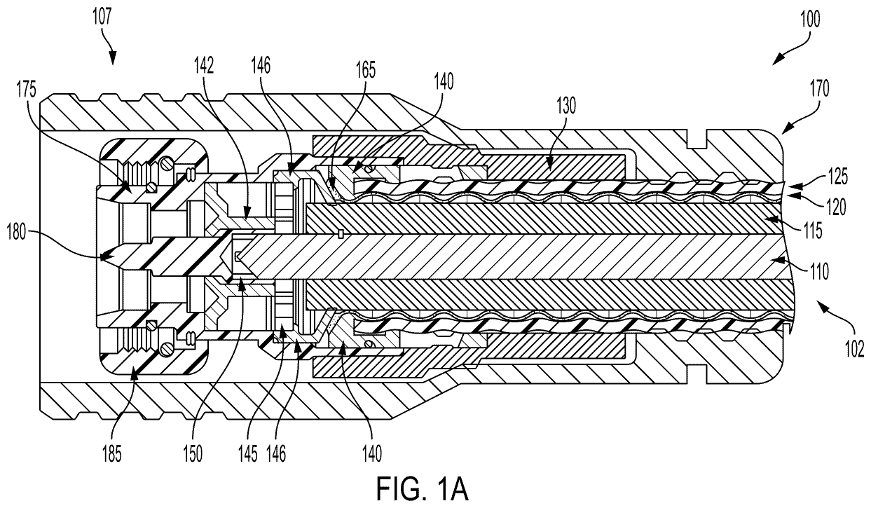

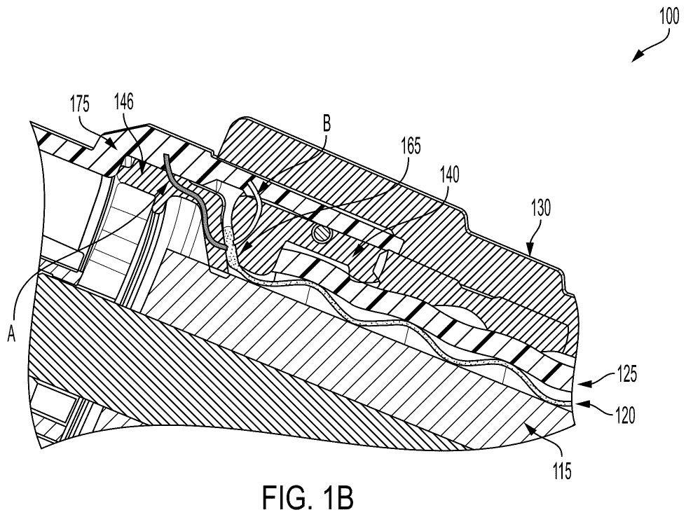

FIG. 1A illustrates one end of an exemplary RF jumper 100 having an exemplary compression connector (hereinafter “connector”) 107 affixed to an RF cable 102 according to the disclosure. RF cable 102 may be a standard RF coaxial cable having an inner conductor 110 that is coaxially surrounded by an insulator 115, which is in turn coaxially surrounded by an outer conductor 120. Disposed on the outer surface of outer conductor 120 is a jacket 125, which may be formed of an insulating and protective flexible plastic. As illustrated, inner conductor 110 may have a prepared end, and insulator 115 and outer conductor 120 may have a section removed so that inner conductor 110 may protrude to where it may engage an inner conductor basket 150 that is mechanically and electrically coupled to connector inner conductor 180.

Connector 107 has a split clamp ring 140 that is disposed within outer connector body 175; and a contact cone 146 that is also disposed within outer connector body 175. As illustrated, split clamp ring 140 and contact cone 146 compressibly grip a flared portion of outer conductor 120 in an outer conductor contact 165. Split clamp ring 140 further grips cable jacket 125 and is adjacent to strain relief cap 130, which extends over outer connector body 175. Disposed over connector 107, strain relief cap 130, and RF cable 102 is a weather protection seal 170.

Connector 107 has an internal mechanism that applies pressure to inner conductor basket 150 as well as to contact cone 146 so that consistent electrical contact may be respectively established and maintained between RF cable inner conductor 110 and connector inner conductor 180; and between RF cable outer conductor 120 and connector outer body 175. This mechanism includes a front insulator 142 and an insulator ring 145.

FIG. 1B is a zoomed in view of connector 107 affixed to RF cable 102. In certain embodiments, contact cone 146 may be formed of a metal, such as brass. A metal contact cone 146 may offer certain advantages in timing of electrical contacts during compression by enabling the flaring of the outer conductor 120 to form outer conductor contact 165 before compressing inner conductor basket 150 around RF cable inner conductor 110. However, it leads to a complication in that it creates an additional conductive path A in addition to conductive path B, through which electrical current may flow between RF cable outer conductor 120 and outer connector body 175. Such dual conductive paths A/B may lead to signal distortion, such as PIM, due to the air gap present between contact cone 146, split ring clamp 140, and connector outer body 175. The dual conductive path issue may be mitigated by having contact cone 146 formed of an insulating material, such as a hard plastic, ceramic coated material, or composite material. In the case of a hard plastic, a high temperature plastic with heavy glass filament may be used. Examples may include 30% glass filled Ultem or 20% glass filled Nylon 6/6.

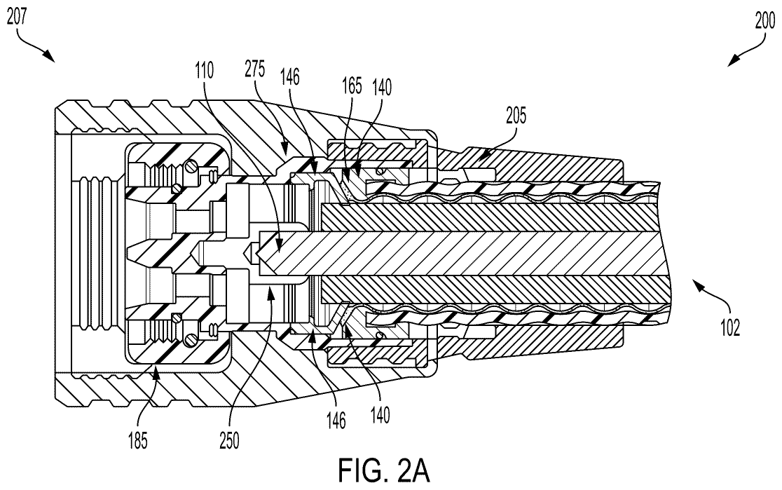

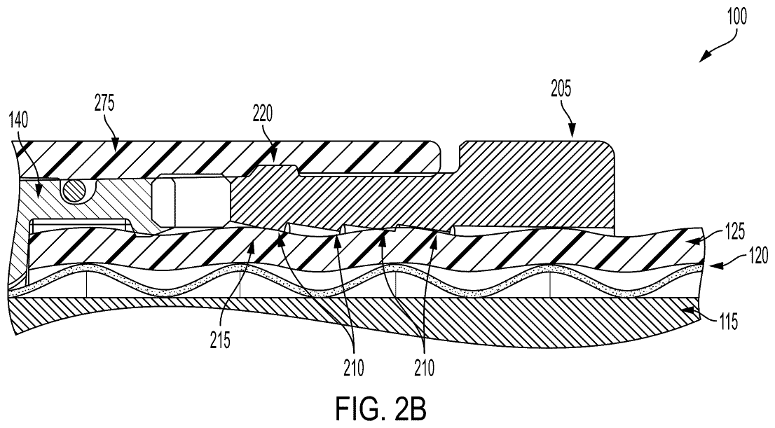

FIG. 2A illustrates another exemplary RF jumper 200 with an exemplary compression connector 207 affixed to an RF cable 102 according to the disclosure. A key distinction between compression connector 207 and compression connector 107 is that compression connector 207 may be lower cost and have a passive center conductor contact, whereby center conductor basket 250 may engage cable center conductor 110 without a compression mechanism like that disclosed with connector 107. It will be understood that such variations are possible and within the scope of the disclosure.

FIG. 2B is a zoomed in view of FIG. 2A, showing another variation, in which strain relief cap 205 has features that enable easier manufacturing and deployment. First, strain relief cap 205 is designed to be inserted between RF cable jacket 125 and connector outer body 275 and has a narrower profile than strain relief cap 130. An advantage of the narrower profile is that it gives strain relief cap 205 a narrower profile than interface 185, making it easier to connect and disconnect jumper 200 from a port (not shown) of an antenna or base station. Second, strain relief cap 205 has a locking tab 220 that engages a radial slot formed in the interior of connector outer body 275. Further, strain relief cap 205 has a plurality of locking ridges 210 disposed on its inner surface. The locking ridges 210 mechanically engage with the outer surface of cable jacket 125, preventing strain relief cap 205 and connector 207 from translating along RF cable 102 during assembly. Third, strain relief cap 205 may have a taper 215 that helps the plurality of locking ridges to mechanically engage with outer jacket 125 during installation, and it helps shift the point of pressure between strain relief cap 205 and connector 207 rearward and away from outer conductor contact 265 (not shown in FIG. 2B).

Although disclosed in the context of compression connector 207, strain relief cap 205 may be used with compression connector 107 of FIGS. 1A and 1B.

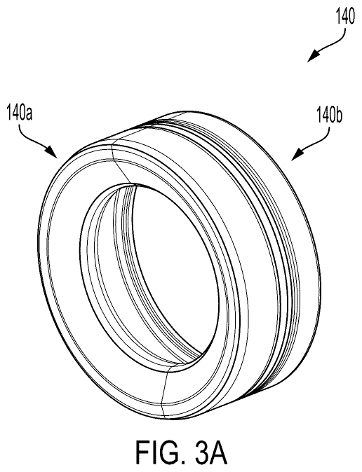

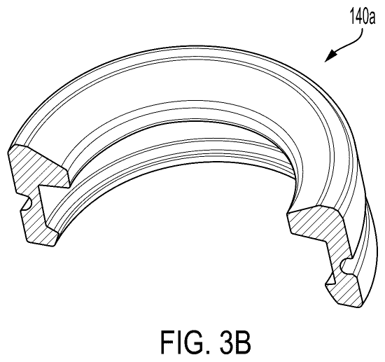

FIG. 3A illustrates an exemplary split clamp ring 140 according to the disclosure. Split clamp ring 140 may be formed of two halves 140a and 140b that are joined together around a prepared end of RF cable 102, whereby the insulator 115 and outer conductor 120 have been removed to expose inner conductor 105. Split clamp ring 140 may be formed of a metal such as brass, primarily because of strength, and compatibility with finishing, such as trimetal plating. Aluminum may be used, but it may be incompatible with trimetal plating.

Split clamp ring 140 enables easier automated manufacture. As illustrated in FIGS. 1A, 2A, and 5D, outer conductor contact 165 includes an outwardly flared segment of outer conductor 120. Under conventional methods, a single piece clamp ring is used whereby it must be slipped over outer conductor 120 and inserted to where the clamp ring is located over a root (or trough) of the corrugation of outer conductor 120. This is straightforward for a person to do, whereby the person grips the cable, locates the clamp ring at the root of the corrugation, and flares outer conductor 120. However, this is difficult to perform using automation. With a split clamp ring 140, a machine may positively engage split clamp ring 140 at the root of the corrugation so that it self-aligns. Once split clamp ring 140 is in place, the machine may then flare the outer conductor 120 to later form outer conductor contact 165.

FIG. 3B illustrates one exemplary half 140a of split clamp ring 140 according to the disclosure.

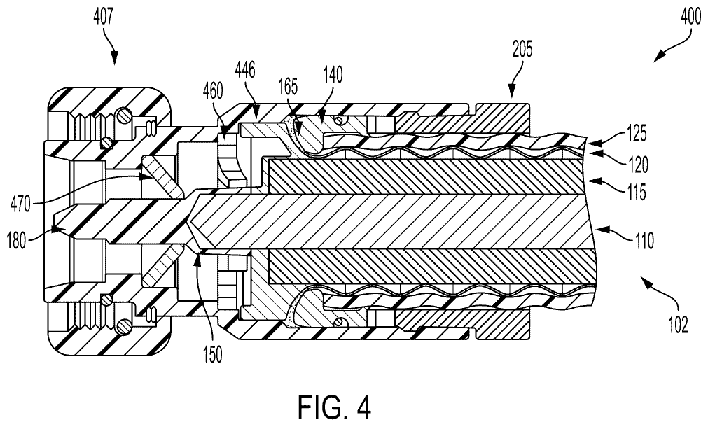

FIG. 4 illustrates another exemplary RF jumper 400 with an exemplary compression connector 407 affixed to an RF cable 102 according to the disclosure. The compression connector 407 has a reduced profile strain relief cap 205 and a two-piece internal mechanism for applying pressure to inner conductor basket 150 and contact cone 446. The two-piece internal mechanism includes a front insulator 470; a secondary basket insulator 460; and a plastic contact cone 446. Plastic contact cone 446 functions in substantially the same manner as contact cone 146 in connector 107. Front insulator 470 provides support for connector inner conductor 180, including pressure in the axial direction during compression. Secondary basket insulator 460 also provides support for connector inner conductor 180 but also applies pressure radially inward to inner conductor basket 150. Having two insulators as disclosed provides improved support and pressure for engaging inner conductor 110 with inner conductor basket 150 during compression. It also reduces the total dielectric within the electrically active portion of the transmission line, reducing dielectric losses observed at high frequency.

Plastic contact cone 446 offers an advantage in that it does not provide a secondary conductive path (A in FIG. 1B), thus preventing signal distortion due to dual conductive paths A/B for the outer conductor.

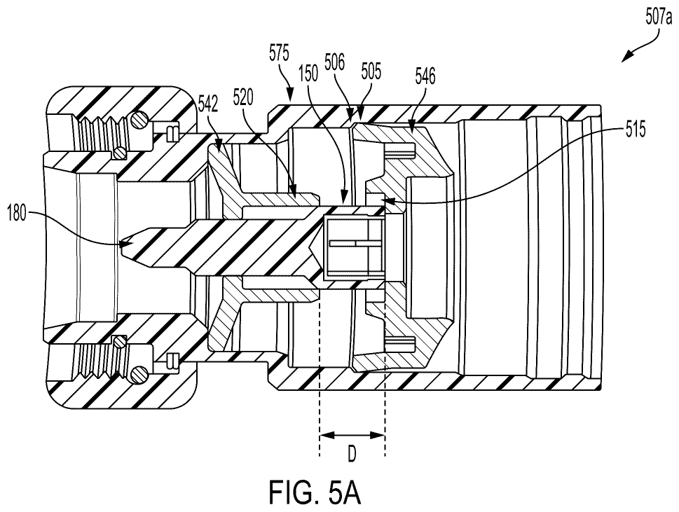

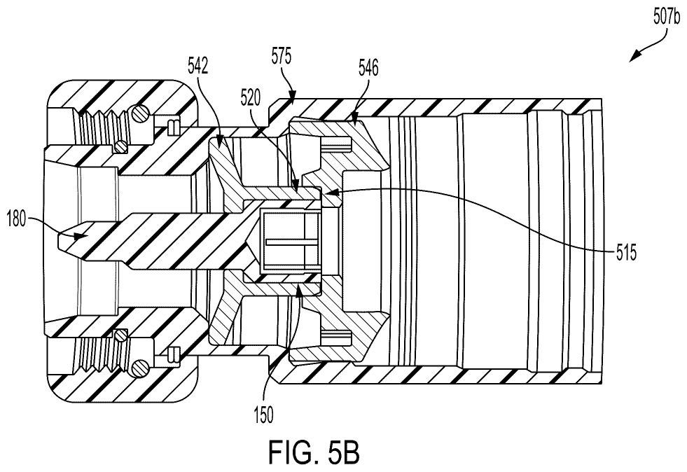

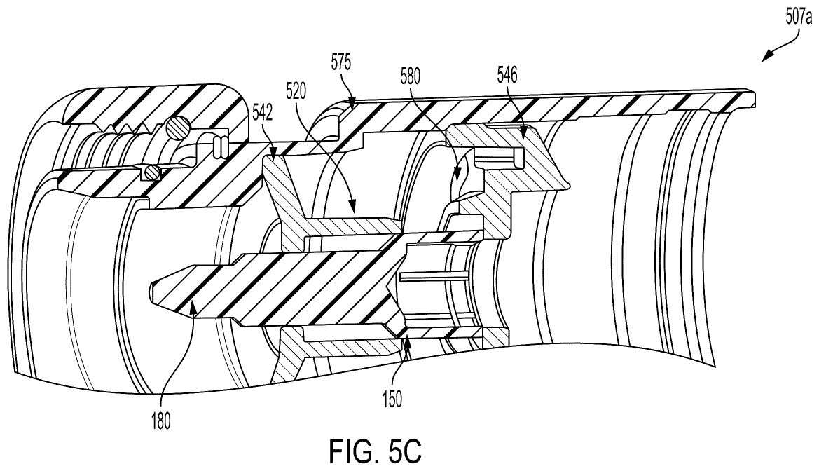

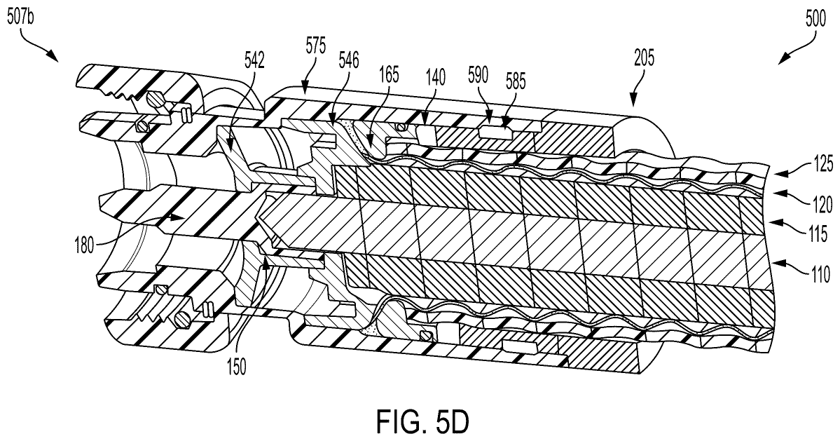

FIG. 5A illustrates another exemplary compression connector 507a in its pre-compressed open state. Compression connector 507 has an outer body 575; and a connector inner conductor 180 that has an inner conductor basket 150. Connector inner conductor 180 and its inner conductor basket 150 may be the same as that described above with respect to compression connector 107. Connector inner conductor 180 may be held in place coaxially with outer body 575 via front insulator 542 and contact cone 546. Contact cone has a forward taper 505 that engages a ramp 506 formed in the interior surface of outer body 575. This feature keeps contact cone 546 substantially fixed in the axial direction when connector 507a is in its pre-compressed state. Contact cone 546 also has a cavity 515 that is configured to accept tab 520 of front insulator 542 during compression. As illustrated, contact cone 546 and front insulator 542 are separated by an axial distance D.

FIG. 5B illustrates exemplary compression connector 507b in its compressed state. It will be understood that, in its compressed state, connector 507b would be affixed to RF cable 102 (not shown), and that there would be a ring clamp (not shown) that with contact cone 546 would grip outer conductor 120 to form outer conductor contact, similar to outer conductor contact 165 of FIG. 1A. During compression, RF cable inner conductor (not shown) gets inserted within inner conductor basket 150, and once in place, contact cone 546 flexes at its taper 505 such that it slides over ramp 506, and then contact cone 546 pushes connector inner conductor 180, along with inner conductor basket 150, in the forward axial direction (leftward) such that tab 520 of front insulator 542 applies inward radial pressure on inner conductor basket 150, thereby securing it to RF cable inner conductor (now shown). The compression process is illustrated by comparing the relative positions of contact cone 546, front insulator 542 with tab 520, and connector inner conductor 180 with inner conductor basket 150 in FIG. 5A to the relative positions of contact cone 546, front insulator 542 with tab 520, and connector inner conductor 180 with inner conductor basket 150 in FIG. 5B. In comparing FIGS. 5A and 5B, it can be seen that contact cone 546 pushes the connector inner conductor 180 and inner conductor basket 150 with the RF cable inner conductor inserted into the inner conductor basket 150 (see FIG. 5D) until the connector inner conductor 180 and inner conductor basket 150 with the RF cable translate a distance D and tab 520 of front insulator 546 engages cavity 515 of contact cone 546 and applies inward radial pressure on the inner conductor basket 150 to tightly secure the RF cable inner conductor inserted therein.

FIG. 5C is another view of exemplary compression connector 507a in its pre-compressed state, including connector outer body 575; contact cone 546, connector inner conductor 180 with inner conductor basket 150; and front insulator 542. As illustrated, contact cone 546, which is plastic, may have a plurality of cutouts 580 that may provide a spring effect to contact cone 546.

FIG. 5D illustrates an exemplary jumper 500 having exemplary compression connector 507b affixed to it. As illustrated, strain relief cap 205 is inserted between RF cable jacket 125 and connector outer body 575. Strain relief cap 205 may have a tab 585 that engages in a recess 590 formed on the inside of outer body 575 that helps fix strain relief cap 205 in the axial direction as well as shift the pressure of strain relief away from outer conductor contact 165.

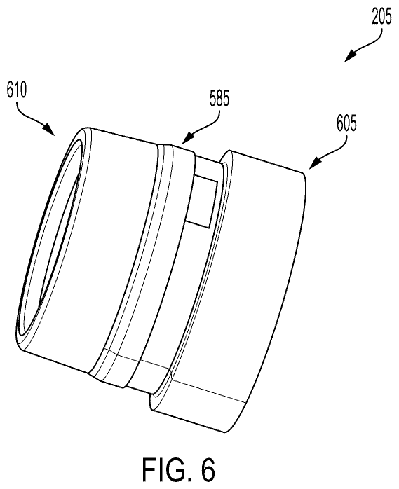

FIG. 6 illustrates exemplary strain relief cap 205, which may be used in any of the embodiments of compression connector disclosed above. Strain relief cap 205 may have a main body having a strain relief sleeve 605 and tab 585 that encircles it, and a gasket portion 610. Strain relief cap 205 may be co-molded such that the main body may be made of plastic, and gasket portion 610 may be formed of rubber.

All plastic parts disclosed above may be formed of a resin, such as Delrin. Generally, the plastic material must have high melting temperature and high compressive strength. Example candidate materials include Ultem (PEI), Delrin (Acetyl), and Glass Filled Nylon 6/6.

1. A compression connector, comprising:
a connector outer body;
a connector inner conductor that is concentric to the connector outer body, the connector inner conductor having an inner conductor basket configured to receive an inner conductor of a radio frequency (RF) cable;
a front insulator mechanically coupled to the connector outer body and configured to be mechanically coupled to the connector inner conductor basket-and apply inward radial pressure on the connector inner conductor basket when the compression connector is in a compressed state;
a contact cone mechanically coupled to the connector outer body and configured to compress a flared outer conductor of an RF cable from a first side;
a split clamp ring mechanically and electrically coupled to the connector outer body and configured to compress the flared outer conductor of an RF cable from a second side, wherein the split clamp ring has two semicircular components that are configured to be joined together during a jumper compression assembly process; and
a strain relief cap partly disposed on an inner surface of the connector outer body.

2. The compression connector of claim 1, wherein the contact cone comprises brass.

3. The compression connector of claim 1, wherein the front insulator comprises a tab portion that is parallel to the inner conductor basket when the compression connector is in the compressed state.

4. The compression connector of claim 3, wherein the contact cone comprises a cavity configured to accept the tab portion.

5. The compression connector of claim 4, wherein the contact cone comprises a plurality of cutouts configured to provide a spring effect to the contact cone in an axial direction.

6. The compression connector of claim 1, wherein the strain relief cap is configured to be positioned between an outer portion of an RF cable and the inner surface of the connector outer body.

7. The compression connector of claim 6, wherein the strain relief cap comprises:
a locking tab disposed on its outer surface, and configured to engage a recess formed on the inner surface of the connector outer body; and
a plurality of locking ridges disposed on its inner surface configured to engage an outer portion of an RF cable.

8. The compression connector of claim 1, wherein the contact cone comprises plastic.

9. A compression connector, comprising:
a connector outer body;
a connector inner conductor that is concentric to the connector outer body, the connector inner conductor having an inner conductor basket configured to receive an inner conductor of a radio frequency (RF) cable;
a first insulator mechanically coupled to the connector outer body and mechanically coupled to the connector inner conductor;
a second insulator mechanically coupled to the connector outer body and configured to be mechanically coupled to and apply inward radial pressure on the inner conductor basket when the compression connector is in a compressed state;
a contact cone mechanically coupled to the connector outer body and configured to compress a flared outer conductor of an RF cable from a first side;
a clamp ring configured to compress the flared outer conductor of an RF cable from a second side; and
a strain relief cap partly disposed on an inner surface of the connector outer body.

10. The compression connector of claim 9, wherein the strain relief cap is configured to be positioned between an outer portion of the RF cable and the inner surface of the connector outer body.

11. The compression connector of claim 10, wherein the strain relief cap comprises:
a locking tab disposed on its outer surface, and configured to engage a recess formed on the inner surface of the connector outer body; and
a plurality of locking ridges disposed on its inner surface configured to engage an outer portion of an RF cable.

12. The compression connector of claim 9, wherein the first insulator comprises a tab portion that is parallel to the inner conductor basket when the compression connector is in the compressed state.
